(19) United States
(12) Patent Application Publication
(10) Pub. No.: US 2004/0148146 A1
(43) Pub. Date: Jul. 29, 2004

(54) Tool for monitoring and controlling a develpment of complex organisms

(76) Inventor: Raoul Barre De Saint Venant, Paris (FR)

Correspondence Address: Michael L Kenaga, Rudnick & Wolfe, PO Box 64807, Chicago, IL, 60664-0807, US

(21) Appl. No.: 10/477,681

(22) PCT Filed: May 2, 2002
(86) PCT No.: PCT/FR02/01515

(30) Foreign Application Priority Data
May 14, 2001 (FR) 01/06313

(51) Int. Cl. G06F 17/10

(52) U.S. Cl. 703/2

(57) ABSTRACT

The invention concerns a tool for monitoring and controlling a complex organism development consisting of interactive components, said tool comprising an operator interface (2, 3, 4) a storage unit (7) and a digital processing unit (6). More particularly, the tool comprises in memory at least a first representation software (11), a document (Develop, xls) of said first representation software, containing pivot objects for modelling each a type of component of the complex organism and a computerised modelling (10) software designed to validate an addition, a modification or elimination in the document of said first representation software, of a duplicated object of structure identical to a pivot object, the duplicated object modelling a component of the complex organism.

The scope of the invention is the monitoring/controlling of the development of a complex organism.

An organism is complex in that it comprises a combination of components which interact with one another and with the outside of the organism, thus defining a behavior of that organism. By successive nesting relationships, each component can itself comprise a combination of sub-components, which in turn are considered components and so on until they comprise indivisible components.

For example, the components of an automobile engine are an engine block, a cooling system, a lubrication system, an electrical system and a clutch system. The engine block comprises cylinders, a connecting rod, a cam shaft and a timing chain. A cylinder in turn comprises a combustion chamber, a piston which interacts with the combustion chamber and upon which interacts the electrical system. In this example, the nesting relationship illustrates how the mechanical, electrical or thermal behaviors of the component depend on those of its sub-components.

For example, a production plant comprises machines, a power supply system for those machines, stores of unprocessed products, and stores of finished or semi-finished products. A machine may comprise a motor, a control station, a tooling system and measurement instruments. In this example, the nesting relationship illustrates how the economic performance (cost, productivity, production capacity, etc) of the plant depends on the technical characteristics of its sub-components.

A further example is a financial holding company comprising several companies as its components. A company in turn comprises production sites and distribution sites. A distribution site can interact with a production site. One company's production site can interact with the production site of another company by supplying it with semi-finished products. In this example, the nesting relationship illustrates the hierarchical relationships between those responsible for components and those responsible for sub-components.

How a complex organism behaves with its environment is described by one or more functionalities defining which external stimuli can modify its behavior. One functionality of the complex organism is linked to a “process” which mobilizes a part of its components or sub-components and which, where appropriate, returns a related service. Each mobilized component constitutes a stage of the “process” and can be likened to the functionality provided at that stage by that component to the process. This functionality is then linked to a sub-process, mobilizing sub-components of that component. So, by degrees, we can associate a complex organism with a tree structure of sub-processes. A process is therefore defined by the data of the component that supplies the functionality, by the functionality itself defined by all the services supplied in response to the stimuli accepted by the functionality, and finally, by all the sub-components that it mobilizes in sequence or in parallel. Certain processes of certain organism have processes the list of services and stimuli of which can be enlarged or reduced. A process reacting to direct stimuli of the complex organism's environment will be called a “global process” and the associated functionality a “global functionality”.

A global function of the engine, cited as an example, is to supply the rotary mechanical energy at the gearbox output. The process associated with it mobilizes an engine block, a cooling system, a lubrication system, an electrical system, a clutch system and a gearbox system. The list of external stimuli is defined as all the possible combinations of pressure on the accelerator, operations of the clutch and operations of the gearbox. Other global functionalities are proposed by the engine such as the engine's behavior according to the external temperature, or the engine's behavior according to external mechanical impacts. A sub-process deriving from the “supply of mechanical energy” global process could be the conversion of an explosive mixture into a rotary movement by all the components in the engine block comprising essentially cylinder, connecting rods, combustion chamber and crank shaft. In this sub-process, each of the cylinders sequentially provides the rotary movement for a part of the complete rotation, that is 360°. Adding a turbocharger to the engine and gearing down the gearbox with a “jaw clutch” are possible methods of increasing the list of services of the process and of the accepted stimuli.

A global function of the enterprise cited as an example can be to respond to a customer need for a given product in the territory of a given market, for example the demand for cars in Europe. The identification of a need by the marketing department triggers the action of the sales department which, when the need has been converted into an order, activates the internal supply chain which, in turn, organizes the action of all the procurement, production, delivery and invoicing departments. The list of needs is defined with respect to the list of products or services in the enterprise's catalog. A production shop where each stage of production, from receipt of the raw materials to final inspection, is carried out on one or more production lines is a sub-process of the internal supply chain process. The list of car models produced by a shop constitutes the list of services provided by the shop that can be enlarged or reduced for example by creating production lines or installing more multi-purpose machines. Furthermore, the enterprise can be considered from the point of view of its other global functionalities such as providing work for the employees, providing contracts to suppliers or providing a home for investments for investors and bankers or causing environmental pollution. So the enterprise is a complex organism offering a vast list of functionalities.

The development of a complex organism involves constructing and/or modifying that organism.

To construct an automobile engine, one defines and assembles its various components, engine block, cooling system, etc. One can modify an engine by changing the dimensions of a combustion chamber or by adding cylinders or adding valves to a cylinder or linking several engines together, installing a turbocharger on the air intake, etc. Modifications to one component have repercussions on one or more other components. For example, increasing the volume in the combustion chamber by increasing the cross section requires an increase in piston surface area. Adding a new sub-component requires the redefinition of all the other components of the organism to accommodate this new component. For example, adding a cylinder to an engine block leads to modifying the crank shaft, the clearance of the other pistons, and, to accommodate the change of weight, the silent blocks linking the engine to the chassis.

To build a factory, we define and assemble its different components, machines, stores, conveyor systems between machines and between machines and stores, etc. We can modify a factory by adding or removing a machine, increasing or decreasing the size of a store. Changes to one component have repercussions on one or more other components. For example, an increase in the number of machines may require an increase in the size of the stores or an increase in the power supply system but also may require a reorganization of the stores to accommodate the stocks for the new production.

To construct a holding company, we define and assemble its different components, companies, sites within a company, production ranges for a company or for a site. We can modify an enterprise by changing a production range or by adding production sites within a company. Changes to one component have repercussions on one or more other components and can lead to changing the definition of certain processes. For example, an increase in the quantity to be sold by a company may require an investment to increase the size of a production site or the number of production sites and/or distribution sites. An increase in the quantities sold has repercussions on one company's sales revenue and on the sales revenue of the whole enterprise. The depreciation resulting from an additional investment has repercussions on the fixed costs and, as a consequence, on the margin and profit of a company and hence of the whole enterprise. Similarly, the acquisition of a new enterprise may lead to the creation of a new department in the holding company head office to monitor its management.

To monitor and control the development of a complex organism, we often use models which include parameters for measuring the complex organism, variables which represent the stimuli from the external environment and computing algorithms which correlate the values of these parameters with one another and with the values of the variables.

In the formulation phase, a model can serve to dimension and lay out the organism and monitor the pace of its development. In the test phase and, where appropriate, during maintenance in operation, the model can serve to adjust the organism. The computing algorithms which correlate the measurement parameter values and the variables serve to predict how a change in the value of a parameter or a variable affects the values of the other parameters and so to monitor and control the development of the complex organism.

Usually, the model is implemented by means of a computer system which receives as inputs the complex organism's measurement values and the values of the variables representing the external environment, and generates at the output other measurement values amongst those concerning input parameters or the organism's control parameters.

Depending on its configuration, the computer system is used to simulate, test or regulate the complex organism.

To simulate the complex organism, the input values come from input means such as a computer keyboard, a mouse or data files. For an engine, the parameters relate, for example, to a number of cylinders, combustion chamber dimensions, the presence of spark plugs for a gasoline engine or the absence of spark plugs for a diesel engine and the variables concern for example the flow of fuel and oxidant. For a factory, the parameters concern, for example, a number of machines, power consumed, store dimensions, the presence of a fluid system for compressed air machines or the absence of a fluid system for fully electrical machines and the variables concern, for example, the quantities to be produced. For an enterprise, these values concern, for example, a number of companies, the date on which a site begins production for a manufacturing company or the absence of production sites for a purely commercial company, sales revenues, quantities produced or sold and costs. The output values are sent to display means such as a computer screen, a printer or data files. They concern, for example, the power, weight, output and fuel consumption of an engine, the sales revenues, the number of employees, the profit, and costs of an enterprise.

To test the complex organism, the input values come from measurement instruments, for example on the fuel consumption, the torque of an engine, on the procurement costs and selling prices of an enterprise. The output values are sent to display means or analysis instruments to calculate an output of an engine or enterprise.

To regulate the complex organism in operation, the input values come from sensors, rotation speed, temperature and position of an accelerator pedal for an engine, and selling price, expenditure and quantities produced for an enterprise. The output values can be sent to actuators, spark plug ignition and fuel inlet valves for an engine, and changes in selling price, initiating the hiring of staff or purchasing supplies for an enterprise. The output values may also be sent to display means to indicate the speed or consumption of the engine, or to indicate the gross margin of an enterprise.

Most frequently, the output values from a model are displayed in representation software which enables the specialist concerned to obtain all the model's results. These results are organized according to a value system by which the specialist can interpret them with maximum reliability, minimum effort and in the shortest possible time. This essential value system may lead to the use of one or more representation software programs. In the example of the engine, the thermodynamic specialist may hope to see all the data concerning a cylinder in the same column of a table and have each category of data such as pressure, temperature, etc placed on the same line in that table. The representation software program used may then be a spreadsheet such as Microsoft Excel (registered trademarks). This same specialist may later want to view all at once the data concerning the engine operating cycle; the data software may then be graphic software such as Microsoft Chart (registered trademarks). In the example of the enterprise, the factory management specialist may wish to see all the data concerning a machine in the same column of a table and have each category of data such as productivity, elapsed time, etc on a single line in that table; the representation software program used may then be a spreadsheet such as Microsoft Excel (registered trademarks). This same specialist may later want to view all at once the project tasks aimed at increasing the production capacity of that factory by installing a new machine; the data software may then be a project management program such as Microsoft MS-Project (registered trademarks).

Many representation software programs not only enable the operator to enter and display input and output data but also have algorithms for computing correlations of values to produce the output data.

The complexity of the organism poses a problem for implementing a model that can be exploited to advantage for several reasons.

An initial reason stems from the organization of the responsibilities for the monitoring control of the development of a complex organism. Most frequently the responsibilities are divided into three aspects: functional, project and strategic. The functional aspect is entrusted to people who, depending on the field of activity, are called project owners, line managers, process managers, etc. In the example of the engine, this may be the engineering department manager and the quality department manager. In the example of the company, it will be the director of the factory to be delivered and the manager of the supply process. These people may wish to view the functional performance of the organism at every stage of its development. The project aspect is entrusted to people who, depending on the field of activity, are called project managers, strategy managers, human resources managers, etc. The person responsible for monitoring engine improvement projects may wish to view the different tasks required to produce the expected result and to analyze in detail what causes them to be triggered and their costs. The strategic aspect is entrusted to people responsible for arbitrating between the functional system and the development system. It involves taking all the decisions on the development of the complex organism concerning the addition/deletion of a component and the addition/deletion of services provided by the processes and finally it may organize its decisions in sequences, called “project”, corresponding to an end result which it will be possible, for example, to check out with third parties. In the example of the engine, this may be the customer and/or the sales department. In the example of the enterprise, it may be the chief executive officer and/or the shareholders.

A second reason stems from the diversity of the functional sub-models that can be used in producing a model. Generally, when a model is suitable for one component of the organism, it is not necessarily suitable for another component. In the example of the engine, a thermal model is suitable for components of a thermal nature or for components on which the thermal nature is modeled. The input and output parameters of such a model obey the laws of thermodynamics and mechanics: increased volume and pressure resulting in combustion in a cylinder. This thermal model is not suitable for the electrical system for which the parameters obey the laws of electricity such as Ohm's law, which gives a current value depending on a voltage, the laws of sequential logic, which determine the instant at which a current is sent to a spark plug according to commands generated by a microprocessor. In the example of the enterprise, an automated production technology model is suitable for components of a productive nature or components on which the automated production technology is modeled. The input and output parameters of such a model obey the laws of production: outflows of material as a function of inflows of material, cost of transformation as a function of quantity of energy consumed or total payroll. The factory model is not suited to a sales unit for which the parameters obey the laws of business: gross margin as a function of selling price, sales revenue as a function of quantity sold. This diversity of possible sub-models means that different specialists may be required to work together in the development of the complex organism. These specialists may be from different cultures, pursue different or even conflicting objectives and be subject to different environmental contexts. In the example of the engine, the combustion expert is not necessarily used to using an electrical model and the opposite applies to the electrician. The combustion specialist may wish to optimize his model in order to increase the engine temperature to obtain better output. Too high a temperature may be incompatible with the electrical conductor resistances that increase proportionally. It is then necessary to set up dialog between specialists taking care to avoid any misunderstandings which would harm the smooth development of the organism. In the example of the enterprise, the sales specialist is not necessarily used to using a production model. The director of one company may wish to increase his gross margin whereas that may reduce the gross margin for another company in the same enterprise. Two factories may be located in different countries thus subjecting their respective directors to different constraints in terms of labor and taxes. An effective dialog between the different protagonists on the development of the organism requires a flow of information that is not always easy to implement.

Another reason stems from the variety of possible representations of a working model. In the example of the engine, certain components can be used for more than one of their characteristics: combustion and mechanical characteristics for example. The same component should therefore be able to be represented both in a thermal model and a mechanical model at the same time and, in addition, changes to the characteristics of that component, when justified, should be reflected in both models. So the specialist of this component, when, for example, he wants to change the grade of steel, can obtain an overview, i.e. thermal and mechanical, of the effects of the change of materials on the behavior of the component. In the example of the enterprise, decisions can be examined from the sales point of view and the point of view of their predicted impact on installed production capacity. So the decision to launch a new product leads to a detailed study of the conditions of its distribution and, concomitantly, to assessing its impact on the enterprise's costs and production capacity.

Another reason stems from the need to produce several variants of the same model before taking a decision or from the great volatility in the make-up of certain complex organisms. In either case, the specialist will want to be able to quickly produce variants of the model by adding or removing one or more sub-model. In the example of the engine, the thermodynamics specialist may want to implement several variants of the same original model by changing, for example, the number of cam shafts per cylinder. In the example of the enterprise, its field of activity may frequently have to be modified by a merger—acquisition adding new activities to its initial activities or broadening their outlets to new markets. This same enterprise may also permanently change the conditions of its operation through a dynamic investment or divestment policy.

To provide a solution to the problem, the invention concerns a tool for monitoring and controlling a complex organism development comprising components which interact with one another.

The tool comprises an operator interface, a memory and a digital processor unit. The tool is characterized in that it comprises in memory:

at least one first representation software program;

a document of said first representation software program, containing pivot objects each for modeling a type of component of the complex organism and its relationships with the other components;

a computer modeling software program organized to access the properties of the objects contained in the document of said first representation software program and modify them and to validate an addition, modification or a deletion in the document of said first representation software program, of a duplicated object of a structure identical to a pivot object and to validate its relationships with the other objects contained in the document, the duplicated object modeling a component of the complex organism.

With this tool, each specialist using the first representation software program can access any object of the model and modify its properties based on his knowledge of the sub-component of the organism to which that object corresponds. The specialist does not have to worry about formatting the information concerning the components relating to his field of competence because the modeling software program automatically accesses the desired components and formats them according to the required page layout.

Also with this tool, each specialist using the first representation software program can recognize in the document of said first representation software program the pivot object or objects for modeling a type of component which relates to his field of competence. Using the representation software program, the specialist can then add an object duplicated by copying a pivot object, modify or delete a duplicated object in order to monitor and control the development of the complex organism by modeling a component which relates to his field of competence. The specialist in question does not have to worry about creating or deleting the links caused by his addition or deletion, because the software program, based on the links linking the pivot object or objects to other pivot objects, automatically validates the actions of the specialist in question. The specialist in question also does not have to worry about the repercussions of his addition, modification or deletion on the duplicated objects modeling components that relate to the field of competence of other specialists, because the computer modeling software automatically validates the actions of the specialist in question.

A specialist may not be satisfied with the first representation software program.

Advantageously, the tool includes at least a second representation software program and the computer modeling program is organized to validate an addition, modification or deletion of an object duplicated in a document of said second representation software program which models a component of the complex organism.

It may be that a duplicated object of the second representation software program models a component modeled by a duplicated object of said first representation software program.

Advantageously, the computer modeling program is organized to synchronize an addition, modification or deletion of an object duplicated in the document of said second representation software program with an addition, modification or deletion respectively of an object duplicated in the document of said first representation software program.

Numerous details and advantages of the invention emerge from the description of the example of embodiment that follows with reference to the appended drawings in which:

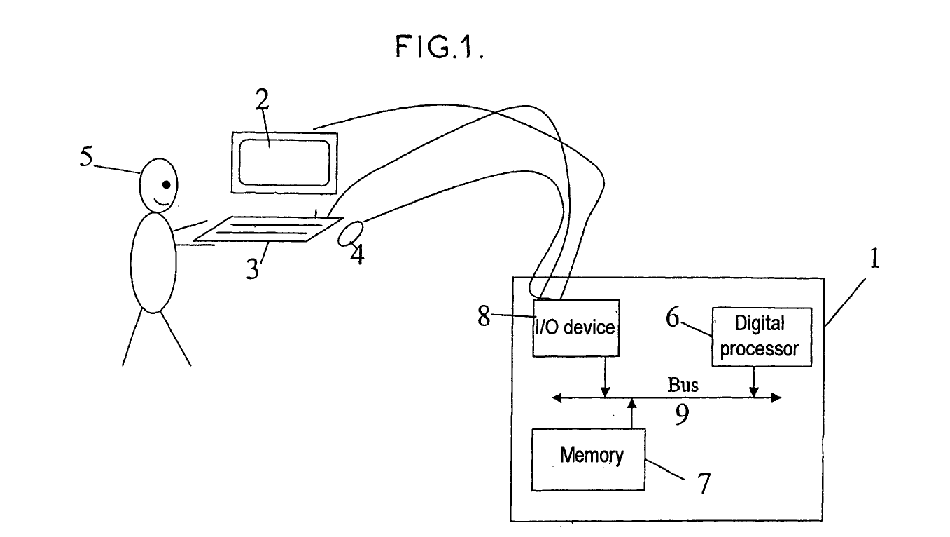

FIG. 1 shows a tool complying with the invention;

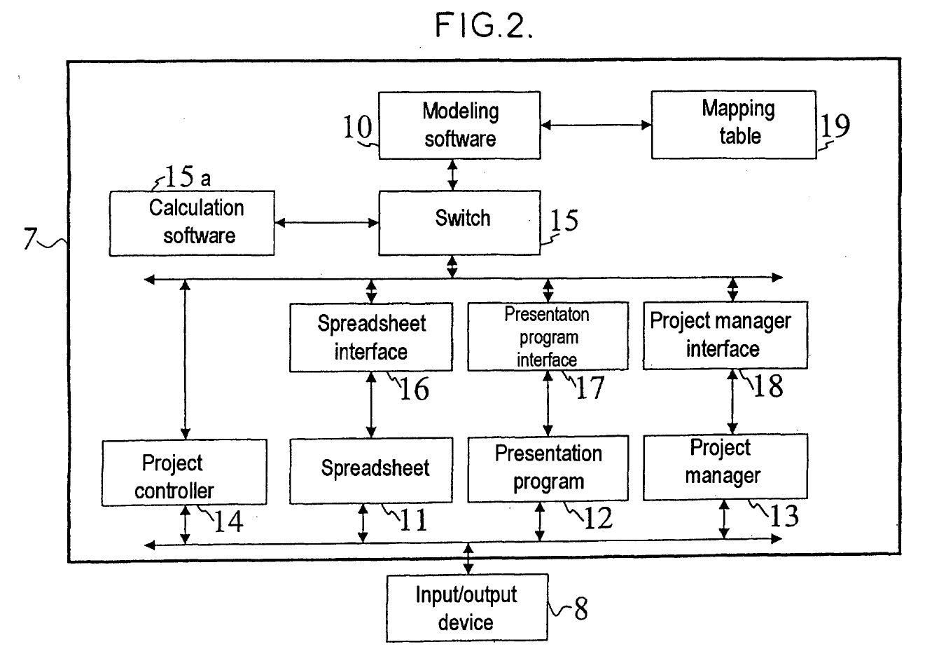

FIG. 2 shows a tool architecture complying with the invention;

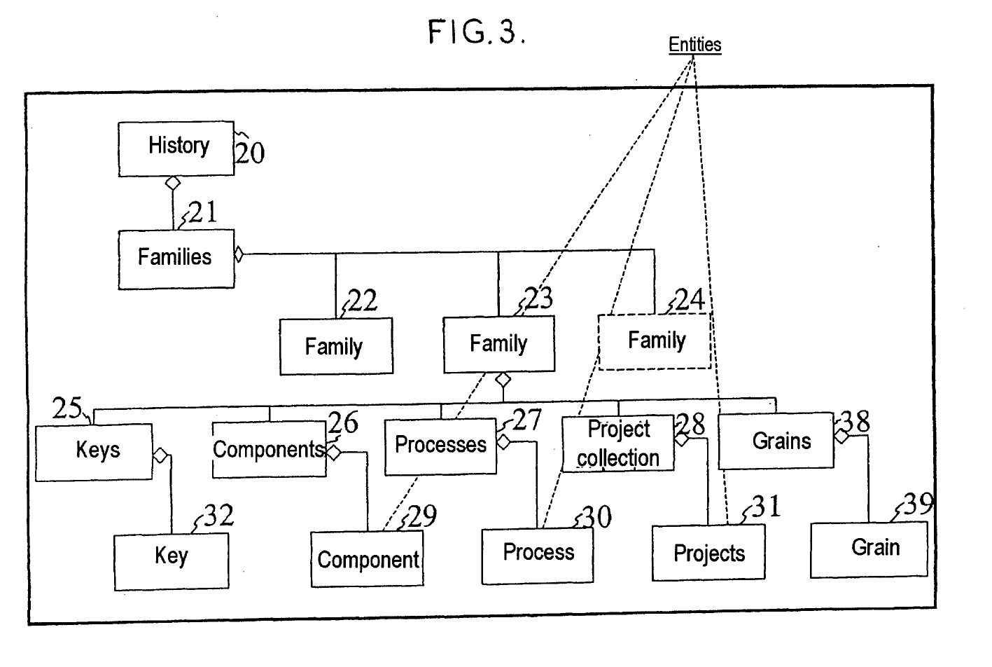

FIG. 3 shows a structure of software objects activated and administered by a modeling software program complying with the invention;

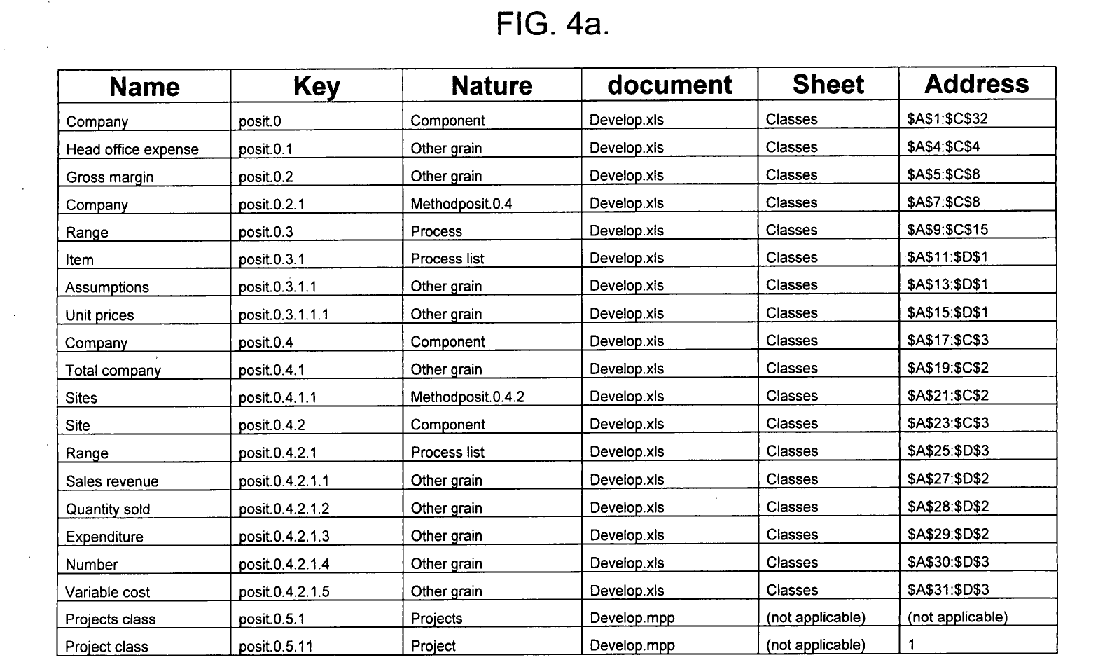

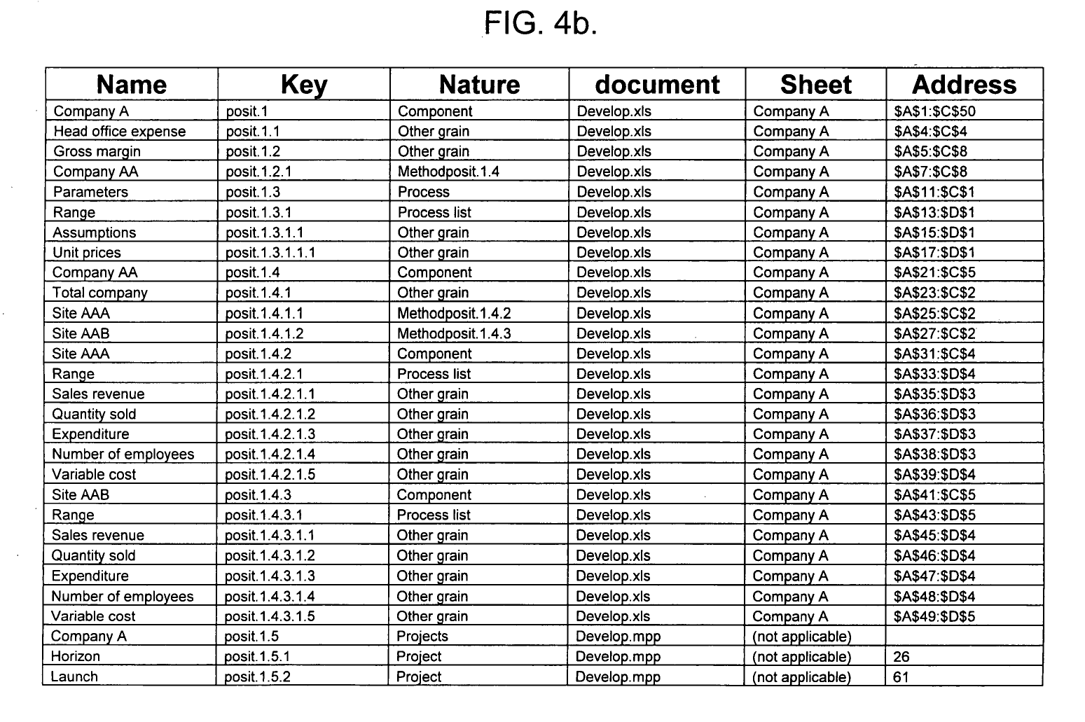

FIG. 4 shows a mapping table consisting of the properties characterizing the links of each object of the software object structure according to FIG. 3 and used to initialize said object structure, and validate and synchronize additions, modifications or deletions of duplicated objects;

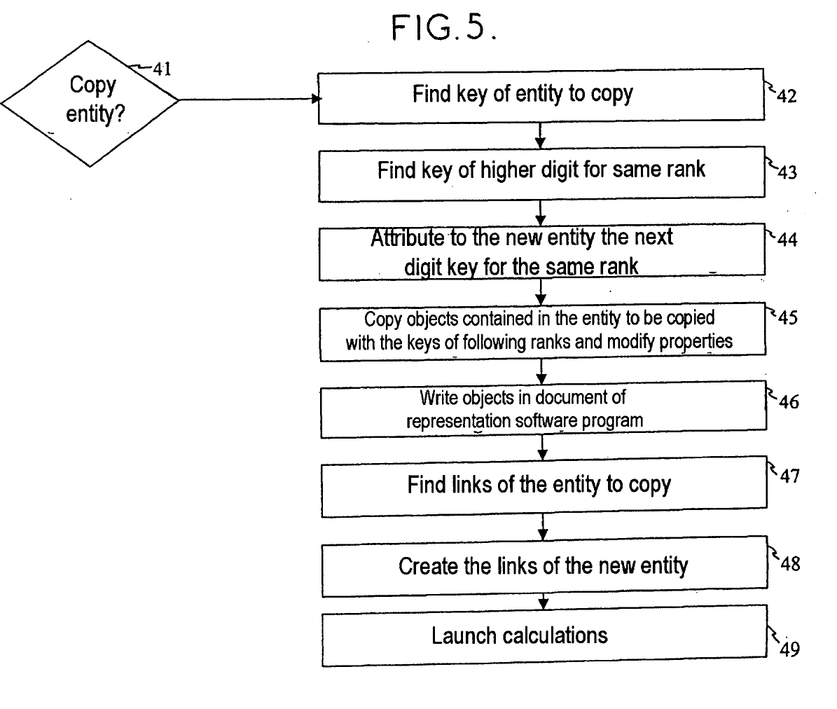

FIG. 5 shows an organization chart for a copy of an object;

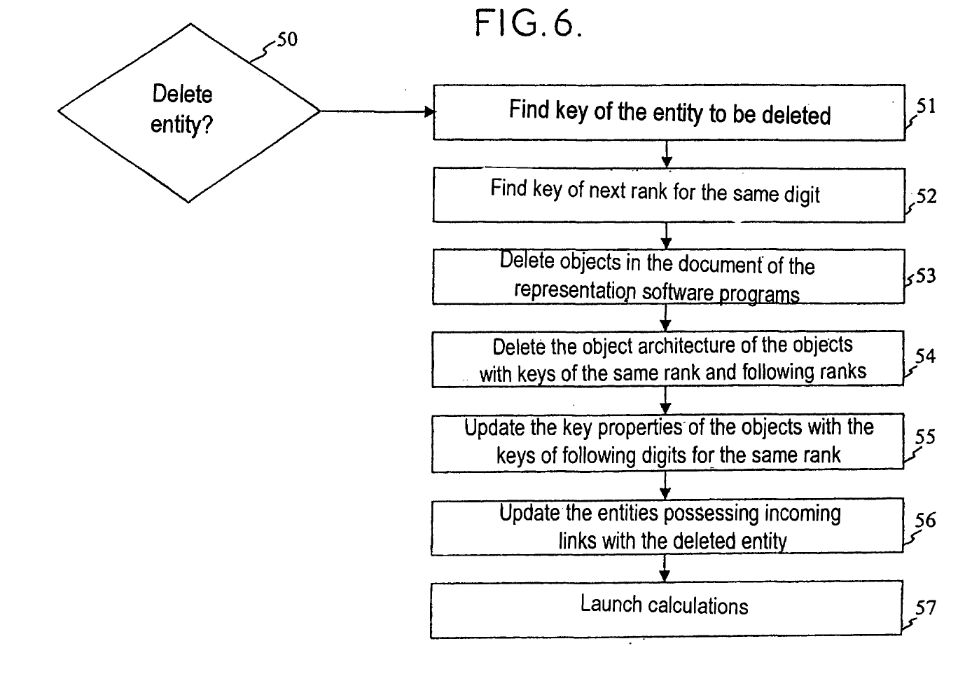

FIG. 6 shows an organization chart for a deletion of an object;

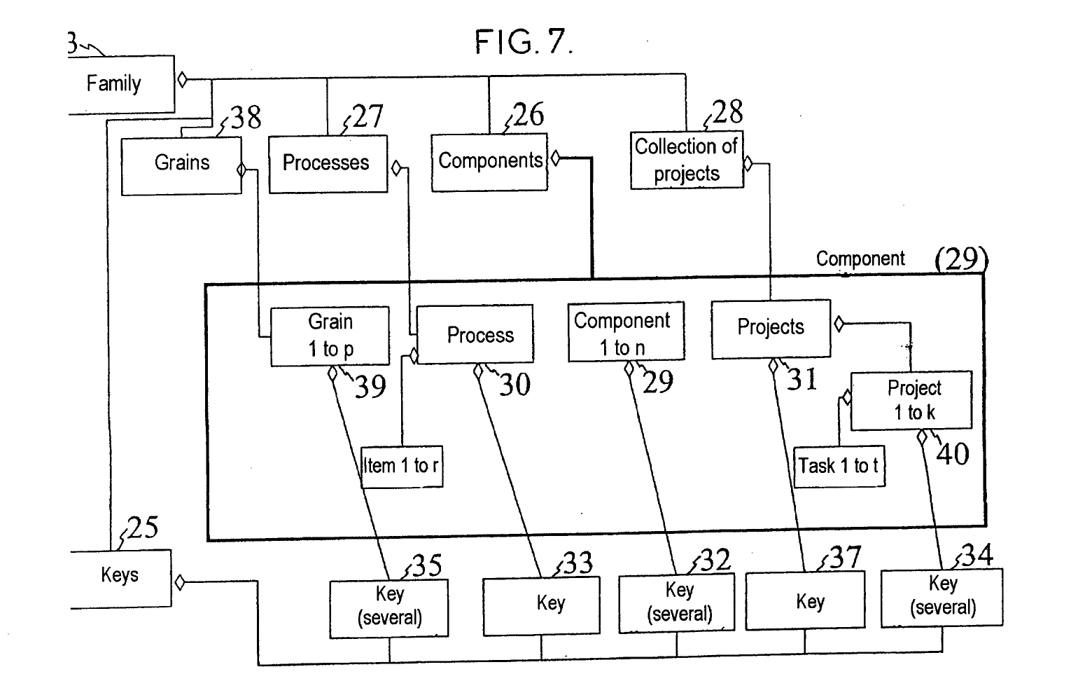

FIG. 7 shows a detail of the components of an object structure managed by the modeling software program, used to explain a method of assigning hierarchical identifiers to a set comprising several collections of objects.

With reference to FIG. 1, a tool for enabling a user 5 to monitor and control a complex organism development is embodied by means of a computer 1 with an operator interface comprising a monitor 2, a keyboard 3 and a mouse 4. The computer 1 comprises a digital processor unit 6 and a memory 7 which is accessed by the digital processor unit 6 via a bus 9. The various elements of the operator interface are linked to an input/output device 8 to which the digital processor unit 6 gains access via the bus 9.

With reference to FIG. 2, the memory 7 of the computer 1 comprises several software bricks 10 to 19. Each software brick comprises a set of programs and data. The programs are contained in files that can be run by the digital processor unit 6. The data are contained in data files accessed by the programs when the programs are run by the digital processor unit 6.

Software bricks 11 to 13 each comprise a representation software program which is provided for communicating with the input/output device 8 in order to display the data on the monitor 2, enter data from the keyboard 3 or mouse 2. Execution of the representation software program by the digital processor unit 6 is usually used not only to display and enter the operator interface data but also to perform calculations on said data.

The representation software program of brick 11 is a spreadsheet. Spreadsheets are known to the specialist and, at this stage of the description, do not require further explanation. As a non-limitative example, one can cite Microsoft Excel (registered trademark).

The representation software program of brick 12 is a presentation program. In prior art, presentation programs are used to show to one or more users sequences of graphics and/or text, animated where necessary and, furthermore, to enable said users to interact with the running of said sequences. One can cite as a non-limitative example Microsoft PowerPoint (registered trademark).

The representation software program of brick 13 is a project manager. In prior art, a project manager is used to monitor the different stages in the evolution of a project by means of Gantt charts, task sequencing flowcharts, and/or detailed data on committed expenditure. One can cite as a non-limitative example, Microsoft Project (registered trademark).

The software program of brick 14 is a controller of all the man/machine interfaces that will be available to the user of the tool.

Software brick 10 is a computer modeling program compliant with the invention to which we will return in greater detail in the rest of the description.

Software brick 10 is organized to interact with software bricks 11 to 13 by means of software bricks 16 to 18 directly or indirectly by means of software brick 15.

Usually, off-the-shelf software is provided with application interfaces enabling a user application to access the data and functionalities of said off-the shelf software. Some off-the-shelf software includes a programming language which enables effective interaction with said off-the-shelf software. For example, Microsoft Visual Basic (registered trademark) can be used to program functions and procedures in Excel, PowerPoint and Project mentioned above. Other programming languages such as C or JAVA by SUN (registered trademark) often allow application interfaces of off-the-shelf software to be used.

Software brick 16 comprises a formatting interface for the spreadsheet. In software brick 16 are programmed functions specially designed for adding, modifying and deleting application objects in documents managed by the spreadsheet 11 and functions for reporting to the computer modeling software 10 all additions, modifications or deletions of application objects made by the spreadsheet 11.

Software brick 17 comprises a formatting interface for the presentation software 12.

Software brick 18 comprises a formatting interface for the project manager 13.

Software bricks 17 and 18 each respectively contain programs specially adapted for adding, modifying and deleting application objects respectively in the documents managed by the presentation software 12 and in the documents managed by the project manager 13 and programs for reporting to the computer modeling software 10 all additions, modifications or deletions of application objects made respectively in the presentation software 12 or in the project manager 13.

Software brick 15 contains administration software to ensure that each formatting interface 16, 17, 18 communicates with each of the other presentation software interfaces and with the object structures managed by the modeling software 10 and furthermore with the project controller 14. In the context of an object-oriented architecture, this switch can be an instance of a class, created by software brick 14 when loading the latter into memory, containing as properties a reference to an instance of the classes proposed by each of software bricks 10, 16, 17, 18.

Software brick 15a is calculation software which can, when required, be substituted for some or all of the calculation functionalities used to carry out the aforementioned calculations in the documents of software bricks 11, 12 and 13. In this case, the functionalities of software bricks 11, 12 and 13 are concentrated on data organization and data presentation functionalities.

Each piece of representation software 11, 12 and 13, in addition to its input, calculation and presentation functionalities, is particularly suited to implementing a model of the complex organism, each in a modeling world of its own, the spreadsheet in the modeling world of functionalities (for example: economic and financial flows), the presentation software in the strategy world, the project manager in the world of decision-making on the development of a complex organism (for example: managing the implementation of a strategy). The memory 7 can contain other representation software programs for modeling the complex organism in other worlds of functionalities such as the world of combustion, the world of electricity and the world of mechanics for modeling an engine. The documents attached to one of these software programs will then be activated and modified using a formatting interface suitable for that software.

With reference to FIG. 3, the modeling software 10 advantageously uses an object-oriented architecture in which each object structure that it manages is a class instance in the computer sense of the term. A mapping table 19, explained below, associated with basic data software, can be used by the modeling software 10 on the one hand to provide the data necessary for the creation of an object structure by 10 and, on the other hand, to find in software bricks 11, 12 and 13 the other information necessary to feed into the object structure. It is possible to replace the mapping table with a mechanism enabling objects created by the modeling software 10 to persist. As a non-limitative example, one can cite an object-oriented database as a mechanism. The modeling software 10 enables the management in memory of objects each composed of object tree structures and here called object structures. The instantiation of a “History” class by the software 10 enables the modeling of a type of complex organism. An object 20 is then associated with a complex organism of a determined type, for example, an enterprise with a particular structure. The object 20 is a root object for carrying out transactions on a collection 21 of objects 22, 23.

In accordance with the prior art syntax of the object-oriented language, each object, a class instance, is defined by a set of properties and methods.

Usually the plural is used to designate a collection and the singular is used to designate each element of the collection. A collection has, at least, the methods normally attributed to collections in the computer sense of the term, in particular “add” to add an element to the collection, “count” to carry forward a number of elements of the collection, “item” to invoke an element designated by an identifier (“key”) or its sequence number in the collection, “delete” to delete an element from the collection designated by its name or by its sequence number in the collection.

The object 20 has as its properties a database called “Db”, a character string called “Db_path”, a character string called “Db_name”, the collection 21 called “Families”, a character string called “Name” and a workspace called “Wrkjet”.

The database “Db” indicates the database software provided to ensure the persistence of the data structures managed by the modeling software 10, where appropriate via the mapping table 19. The character string “Dbname” indicates the name of the file that contains a data structure such as the mapping table 19. The character string “Dbpath” indicates the path for accessing the data file indicated by the character string “Dbname”. The collection “Families” is a collection of objects 20, 23 of the “Family” type explained below. The character string “Name” indicates the name of the object 20 to distinguish it from any other instances of the “History” class. The workspace “Wrkjet” indicates, where appropriate, the execution environment of the mapping table 19 for the object 20.

The object 20 has as its method a procedure called “Setfamily” to pass to an object 22 of the collection 21 the properties of another object 23 of the collection 21.

The collection 21 has as its property a reference to the object 20 to which it is aggregated. Each object 22, 23 represents an object structure managed by the modeling software 10. This computer model models models of one and the same complex organism, each included in a document of representation software programs 11, 12, 13. Each addition or deletion of a duplicated object in a model of the complex organism as it appears in a document of the representation software programs 11, 12, 13 defines a new object 24 in the collection 21 by using the “addition” method of the object 20.

A family-type object such as the object 23 may comprise, as indicated in FIG. 3, several collections of objects such as a collection 26 of objects of the “component” type, a collection 27 of objects of the “process” type, a collection 28 of objects of the “project” type, a collection 38 of objects of the “grain” type and a collection 25 of object of the “key” type. All the elements of the “component”, “process”, “projects” and “grain” types are numbered individually by a collection 25 comprising objects of the “key” type. A key object has as its properties hierarchical identifiers and/or character strings, each of these properties identifying in a document attached to a representation software program a range of locations associated with the object of the object architecture having said key object.

The objects of the “component”, “process” and “projects” type, each being likely to be assigned by add or delete operations and all comprising one or more objects of the “grain” type themselves likely to be assigned by modification operations, are considered as deriving from the same supertype here called “entity”.

Each object of the “component” type 29 of the collection 26 represents in the computer model a real component of the complex organism as modeled by an object duplicated in one or more representation software programs 11, 12, 13. If the object 20 is provided to model an enterprise, an object 29 of the collection 26 can represent a holding company, one or more other objects 29 of the collection 26 may each represent a company owned by the holding company, one or more other objects 29 again of the collection 26 may each represent a company site.

Each object of the “process” type 30 of the collection 27 represents in the computer model a process that coordinates the behavior of one or more real components of the complex organism. An object 30 of the computer model consists of a collection of objects of the “service” type each representing a possible use of all the components thus coordinated. If the object 20 is provided to model an enterprise, an object 30 may represent the management of the product range, the production of that range being performed on one or more sites, each of them contributing to the creation of a specific stage of added value. On a spreadsheet, the number of services of a process usually corresponds to the number of columns, less a constant whole number, of the fields associated with the components concerned in the process. This constant value corresponds to the columns of the spreadsheet page that are used to indicate the line titles and to space out the page format.

Each object of the “projects” type 31 of the collection 28 represents in the computer model a collection of “projects” objects. A “projects” object represents a collection of “project” object. A “project” object represents a development path of a complex organism aiming at a determined functional modification and culminating in a useful result for the specialists responsible for monitoring and controlling the complex organism. A development path includes a sequence of one or more additions, deletions or modifications of components. Each element of the sequence can be represented in the project manager software programs by a “task” characterized by the properties of task start date, task end date and consumption of resources programmed in the same software. For each addition or deletion of a “component” object, of a “service” object in a “process” object or of a “project” object in a project collection (“projects”) and for each modification of a “component” object, a task is created. The values of the properties of the tasks may in return, via software brick 15 and after a possible mathematical reprocessing, serve as parameters to the documents attached to software bricks 11 or 12.

Each object of the “grain” type 39 of the collection 38 represents a qualifier of objects 29, 30 31 containing properties such as a list of strings describing links (formula, pointer) between entities and a list of constants, a list of services proposed by a process, a denomination, a task or a resource of a project manager.

In the representation software program 11, which is a spreadsheet, the duplicated entity A has an incoming calculation link when it contains a formula for calculating a value according to one or more values of other duplicated entities not contained in A such as a company total which summates the sales revenues of several sites. Conversely, when a duplicated entity, not nested in a duplicated entity A, contains a formula which uses a value of entity A, there is an outgoing calculation link for A. In a representation software program 11, a process link associates a range of cells, corresponding to a component of the model mobilized by process, with a range of cells corresponding to another component of the model, mobilized by the same process. In the representation software program 12 which is a presentation program, a link is represented by an oriented connector linking two entities each modeling a physical component such as a company and a site of that company and, more often, evokes any link that may exist between the two entities in another representation. In the representation software program 13 which is a project manager, a link of precedence is an indicator of a task which precedes another task according to a particular requirement the list of which is usually preprogrammed in the same project manager software programs. A resource link links a task with a resource represented in the same software program.

All the links associating one entity A with another entity B in an object structure managed by the modeling software 10 and in the documents of the representation software programs 11, 12 and 13 are contained in the properties links of entity A.

A collection can have a hierarchical structure indicating a nesting relationship linking a part of the elements of the collections with any element of those collections. This hierarchical structure can be described by assigning to each element of the family a unique hierarchical identifier. Each hierarchical identifier comprises a sequence of integers separated by a dot, here each integer in the sequence is called a digit. A hierarchical identifier begins with a character string common to all the hierarchical identifiers, simply to avoid confusion with a number.

Depending on the representation software programs, the use of a hierarchical identifier is not necessary and the reconstitution of the order in the nesting relationship can be carried out using other systems of indexation such as, in a spreadsheet, by linking a range of cells to each element so that the range of cells of a nested element is included in the range of cells of the nesting element. Similarly, in a presentation program, this reconstitution can be based on the location of the elements in a series of slides each possessing a title and several shapes and where each nesting element is represented only once as a title and where each nested element is represented only once as a shape.

A hierarchical identifier system is used to describe the nesting relationships between the components of the complex organism modeled in the object structure and where necessary in each representation software program. For each nesting relationship, an additional digit is added after a dot at the end of the key to define a nesting order. For example, the key posit.0 is attributed to the object named “Enterprise” which models the complex organism. The key posit.0.4 is attributed to the object named “Company” to indicate that this object models a first component of the nested complex organism. The key posit.0.4.2 is attributed to the object named “Site” to indicate that this object models a second component nested inside the first component. For each constituent of one and the same object, the digit corresponding to the constituent's nesting level is incremented. As a further example, the keys posit.1.4.2 and posit.1.4.3 are attributed respectively to the components named “Site AAA” and “Site AAB” which model constituents of the component named “Company AA”.

A system of hierarchical identifiers is used to interlace several tree structures that may each be monitored either individually or as a single total tree structure fixing a nesting relationship for all the elements contained in that tree structure. For example, the tree structure of objects of the “component” type described above is interlaced with a tree structure of objects of the “other_grain” type identified by the keys posit.0.3.1.1 and posit.0.3.1.1.1 respectively attributed to the objects named “hypotheses” and “unit prices”, with the total tree structure causing the object of the “other_grain” type named “hypotheses” to depend on the object of the component type named “enterprise”.

In general, the constitution of a tree structure built from several collections can be constrained by a set of rules limiting the nesting possibilities. The example of FIG. 7 shows a constrained “component” object. It comprises several objects of the “grain” type, the list of which depends on the type of component, a single entity of the “process” type, one or more objects of the “components” type and a single collection of the “projects” type. This sort of constraint can be implemented more easily using classes of computer objects of which the properties are fixed in advance. For example, one can act in three stages as follows. In a first stage, one creates with a computer development tool such as Microsoft Visual Basic (registered trademark):

1) a class “keys” 25 constructed to contain a collection of hierarchical identifiers,

2) a class “component” 26 constructed with a property (=“property let/get/set” in Microsof Visual Basic language), a property collection of objects of the “grain” type, a property of the “process” type and a property of the “projects” type,

3) a class “components” which contains a collection of objects of the “component” type described above,

4) a class “family” which contains an object of the “components” type.

In a second stage, one places in the creation procedure (“create” event with Visual Basic 5) of the component class the lines of code assigning it the number of objects of the entity type, depending on its nature, and the number of objects of the expected grain type. In a third stage, one creates in the family class a procedure “update_identifier”, which assigns a new hierarchical identifier for each object contained in the “component” class at the time of each addition of a new instance of the “component” class in an instance of a “components” class and which updates the list of hierarchical identifiers after deletion. Each object of the “key” type of collection 25 possesses a series of properties the values of which are used to reconstitute the nesting relationships in distinct software applications, where appropriate the tree structures constituted of objects 29, 30, 31, 39 or 40 contained either in the object structure managed by the modeling software 10 (property “key” in FIG. 4), or in the spreadsheet 11 (properties “Document”, “Sheet”, “Address” in FIG. 4) or in the presentation program 12 or in the project manager 13.

Each object of the family type possesses a method “objectidentification” to extract from a collection of keys 25 the list of keys corresponding to all the objects of a given type and created from a precise pivot component. This method is used in particular to return the key of the child element of the list of objects of a given level in the object tree structure which will need to be known when an entity is added.

The mapping table 19 is shown in FIG. 4 in the form of a six-column table. The mapping table can include other columns for entering additional information contained in the collection 25 “keys”, all that is shown here being the columns essential to understanding the embodiment of the invention here described. The columns are given titles in turn beginning with the left-hand column: key, name, nature, document, sheet, address. Each line in the mapping table refers to a modeling object contained in the object structure managed by the modeling software 10. For each object referenced by a line, the column entitled “name” indicates a name attributed to the object, the column entitled “nature” indicates a nature of that object from the types represented in FIG. 3, at least one column is used to identify the document of the presentation software in which the object is situated and, where necessary, a sub-part of the document in which the modeling object is found, the column entitled “sheet” is for identifying the sub-part of the document in which the object is situated, the column entitled “address” indicates an exact location of the modeling object in the form of a range of addresses or a pointer in the document in which that object is found. For example, for a spreadsheet document such as Develop.xls, the address indicates a range of cells which constitutes the object in the sheet which has its name in the column entitled “sheet”. The column entitled “key” includes a hierarchical identifier, the property of a key object of the collection 25, different for each line in order to designate in unique fashion each modeling object contained in the object structure managed by the modeling software 10.

The object structure managed by the modeling software 10 is used by the modeling software by means of programs resident in the memory 7, the organization charts of which are given in FIGS. 5 and 6.

With reference to FIG. 5, when, in a stage 41, the modeling software detects that an entity has been duplicated by copying into a representation software program 11, 12, 13, it activates a series of stages 42 to 49.

In stage 42, the modeling software 10 finds in the object structure the key of the entity that has been used as the basis of the copy. The rank of nesting of that entity is given by the number of dots in the character string of the hierarchical identifier describing the nesting in the object structure.

In stage 43, the modeling software 10, using the “objectidentification” method of the active family object, looks in the object structure for the entity with the hierarchical identifier with a higher digit for the same rank created from the entity that has served as the basis of the copy, that is the hierarchical identifier in which all the digits are the same as that of any of the entities created from the object designated by the hierarchical identifier found in stage 42, except for the last digit. After having identified this entity, the modeling software returns its hierarchical identifier. If an object created from the object designated by the hierarchical identifier found in stage 42 does not exist, the modeling software program 10 identifies in the object structure the parent entity of the duplicated entity, that is the entity at the level immediately above the duplicated entity and returns the hierarchical identifier of that parent entity to which it adds a higher digit equal to 1.

In stage 44, the modeling software 10 calculates a hierarchical identifier for the duplicated entity resulting from the copy. The hierarchical identifier calculated is equal to the hierarchical identifier found in stage 43 with the exception of the last digit which is incremented so that the calculated key constitutes a key with the next digit for the same rank. The modeling software 10 adds to the object structure an object of the same nature as the entity that has served as the basis for the copy and attributes to it as a key property the key containing the calculated hierarchical entity, as the “name” property the name proposed by the user, and as the “nature” property the name of the document in that of the entity that has served as the basis of the copy.

In stage 45, the modeling software 10 creates in the data structure a copy of the objects of the entity that has served as the basis of the copy and of which the hierarchical identifiers are of the rank following the hierarchical identifier found in stage 42, that is the objects that refer to the constituents of the component modeled by the duplicated entity and so on until the last degree of nesting. In the hierarchical identifier of each new object, the modeling software 10 replaces the rank digit identical to that of the digit calculated in stage 44 with the digit incremented in stage 44.

In stage 46, the modeling software 10 and software bricks 16, 17, 18 write in the documents of the representation software programs the objects of which the hierarchical identifiers result from stages 44 and 45 after which the modeling software writes in the mapping table column entitled “address” the location of each object written in the document of the representation software program.

In stage 47, the modeling software 10 constructs the links of the new entity according to the links linking the pivot entity of the other entities. This link construction function can allow as a variable the type of component to which the new object is to be attached in the object tree structure managed by the modeling software 10 but this does not depart from the scope of the present invention. The construction of links may relate to the incoming links of the duplicated object with a symmetrical procedure without departing from the scope of the invention. For this, the interface software brick looks in the object structure for the outgoing links of the entity of which the key is given in stage 43. This search is carried out by identifying in the “nature” properties all the strings containing a character string equal to “method” & “key” resulting from the concatenation of the “method” string with the hierarchical identifier found in stage 43. The hierarchical identifier of the object containing this string is called the “hierarchical identifier of the object associated with an outgoing link” of the entity concerned. By construction, the objects containing the end points of the outgoing links of the entity that has served as the basis of the copy are the end objects of the links of the duplicated entity. When, in a representation software program, these objects are not represented, since all the objects of the grain type are not necessarily represented in all the representation software programs, whereas they are all represented in the object structure managed by the modeling software 10, the end point of the link is the object of the closest higher level in the tree structure.

In stage 48, for each outgoing link found in stage 47, the modeling software 10 creates a new “positionmethod” object, attributes to it the hierarchical identifier key equal to the hierarchical identifier of the object associated with the outgoing link according to the definition explained above with the number of the higher rank incremented by 1, then the interface software brick modifies the documents of the representation software programs to create in them the outgoing links of the duplicated entity.

With many representation software programs, this duplication procedure can be done by relying in whole or in part on the methods proposed by the representation software programs themselves. In a spreadsheet, this involves modifying the target object of this link so that it takes account of the address of the grain created for the new entity. For example, it may consist in adding to the parent entity, in the object structure, of the target of the link a “grain” object of the “positionmethod” nature serving as the end point of the link. The “spreadsheet interface” software 16 then adds to the spreadsheet a line containing the simple references to the spreadsheet cells corresponding to the grain containing the values situated at the origin of the link of the new entity; the values of the cells of the target grain of the new link as well as all the values contained in the cells associated with the preexisting “positionmethod” grains and of the same rank can then be summated in a formula placed by the “spreadsheet interface” software in the cells associated with the parent of the target entity of the link (for example “=sum(C1:C5)” in Microsoft Excel (registered trademarks). In a presentation program and in a project manager, this more simply consists in activating respectively the “presentation interface” 17 software and the “project manager interface” 18 software so that it programs the document to take account of the existence of the links between the objects concerned.

In stage 49, the software bricks update the calculations described by the formulae, constraints and functionalities programmed in them. If a software brick 15a, specializing in computations, is implemented, these calculations will be performed in that software brick and the results passed to software bricks 11, 12 and 13.

The results obtained by activating the stages that have just been described with reference to FIG. 5 will be better understood using the following example.

Consider the mapping table 19 initially completed in FIG. 4 with the lines in which the hierarchical identifiers begin with posit.0. The objects referenced by those lines constitute the pivot objects that model a type of complex organism, for example here a component named “company” consisting of diverse entities (components, processes and projects) and grains.

For the purposes of presentation, FIG. 4 is divided into two figures, 4a and 4b. It will be understood that the lines of the mapping table shown in FIG. 4b follow directly on from those shown in FIG. 4a.

Assume the creation of a company A using the representation software program 12 by copying the pivot object “company”. Stage 41 detects this copy of a pivot object. Stage 42 finds the hierarchical identifier posit.0. Stage 43 finds the digit 0 to be the highest for this rank. Stage 44 attributes to company A an object of the component nature with a hierarchical identifier calculated equal to posit.1. Stage 45 creates the eighteen objects following the first line by replacing the number 0 with the number 1. Stage 46 writes in the Develop.xls document the objects referenced on the first seventeen new lines obtained and writes in document Develop.ppj the last two new lines obtained. Stage 47 writes in the mapping table column entitled “address”, the addresses of the ranges of cells in which the objects have been written in the Develop.xls document concerning a spreadsheet.

Assume the creation of a site AAB by duplication of a site AAA of company A by means of the representation software program 12. Stage 41 detects this copy of an entity by means of the interface 17. Stage 42 finds the hierarchical identifier posit.1.4.3. Stage 45 creates seven new objects by duplicating in the object structure the objects that have the hierarchical identifiers from 1.4.2 to 1.4.2.1.5 by replacing in each hierarchical identifier the number 2 with the number 3 in rank 3. Stage 46 writes in the document Develop.xls the objects thus duplicated and, in return updates the mapping table in particular by writing in the mapping table column entitled “address” the addresses of the ranges of cells in which the objects have been written in the Develop.xls document.

Stage 48 finds a hierarchical identifier of the end object of the outgoing link: position 1.4.1.1.

Stage 49 creates a new “positionmethod” object and attributes to it the hierarchical identifier 1.4.1.2 and then modifies the spreadsheet document to include in it an outgoing link to the newly duplicated entity.

The keys of the objects in the mapping table constitute a collection of keys 25 having as properties a hierarchical identifier relative to the position of the objects in the object tree structure. The hierarchical identifier posit.1.4 constitutes a property for a key object 32 for a component 29. The hierarchical identifier posit.1.3.1 constitutes a property for a key object 33 for a process 30. The hierarchical identifier posit.1.5 constitutes a property for a key object 37 for a project collection 31. The hierarchical identifier posit.1.5.1 constitutes a property for a property object for a key object 34 for a project 40. The hierarchical identifier posit.1.1 constitutes a property for a key object 35 for a grain 39. In the mapping table in FIG. 4, there is no hierarchical identifier for a collection of grains 38 but the key object corresponding to that property and other key objects for other natures of components can be attributed to them without departing from the scope of the present invention. The grain object concerns a constant such as a unit price (posit.1.3.1.1.1), a formula calculating a sales revenue (posit.1.4.2.1.1) or a process list containing the list of names of the services of a process like 1.4.2.1 which is used to locate a spreadsheet line (by convention, here, the first line in the field (A33:D40) containing in each of the cells starting from the third the list of services of the process (one service in this instance).

With reference to FIG. 6, when, in a stage 50, the modeling software 10 detects that an entity has been deleted from the representation software program 11, 12, 13, it activates a series of stages 51 to 57.

In stage 51, the modeling software 10 looks in the object structure for the hierarchical identifier of the entity that has been deleted. The nesting rank of this entity is given by the number of dots in the character string of the hierarchical identifier associated with it.

In stage 52, modeling software 10 looks in the object structure for the objects with hierarchical identifiers of the next rank for the same digit, that is the hierarchical identifiers with a number of dots greater than that of the hierarchical identifier found in stage 51 and integers identical to those of the hierarchical identifier found in stage 51 for each rank lower than the nesting rank of the deleted object.

In stage 53, interface software bricks 16, 17, 18 and the modeling software 10 delete from the documents of the representation software programs indicated by the column entitled “document” each object referenced with a hierarchical identifier found in stage 52.

In stage 54, the modeling software 10 deletes the objects from the object structure identified by the hierarchical identifiers found in stage 51 and in stage 52.

In stage 55, the modeling software 10 updates the objects of the object structure by modifying each hierarchical identifier that is the property of an object for which the digit in the lower rank to that of the nesting rank of the identifier of the deleted object is equal to the digit in the same lower rank for the hierarchical identifier found in stage 51 and for which the digit with a rank identical to the nesting rank of the deleted object is greater than the digit of the hierarchical identifier found in stage 51. The modification involves decrementing the digit of identical rank to the nesting rank of the deleted entity.

In stage 56, the modeling software updates the entities containing the ends of the outgoing links of the deleted entity by deleting the “positionmethod” objects referring to said deleted entity.

In stage 57, the software bricks update the calculations described by the formulae, constraints and functionalities programmed in them. If software brick 15a, specializing in calculations is implemented, those calculations will be carried out in that software brick and the results passed to software bricks 11, 12 and 13.

The teaching of the invention is not restricted to the examples described above. In particular, the tool is not necessarily limited to a single computer but can be distributed over several computers. Each computer (1) then has in its memory a communication program for setting up over a network a communication session with the digital processor unit of another computer, another operator interface or another similar memory. Advantageously, this allows several specialists to work in parallel on the development of a single complex organism, each having a tool complying with the invention at his disposal.

1. A tool for monitoring and controlling a complex organism development consisting of components that interact with one another, comprising an operator interface (2, 3, 4), a memory (7) and a digital processor unit (6), characterized in that it comprises in its memory:
at least one first representation software program (11);
a document (Develop.xls) of said first representation software program, containing pivot objects each for modeling a type of component of the complex organism and its relationships with the other components;
a computer modeling software program (10) organized to access the properties of the objects contained in the document of said first representation software program and modify them and to validate an addition, modification or a deletion in the document of said first representation software program, of a duplicated object of a structure identical to a pivot object and to validate its relationships with the other objects contained in the document, the duplicated object modeling a component of the complex organism.

2. The tool for monitoring and controlling a complex organism development as claimed in claim 1, characterized in that it comprises at least a second representation software program (12) and in that the computer modeling software program (10) is organized to validate an addition, modification or deletion of an object duplicated in a document of said second representation software program which models a component of the complex organism.

3. The tool for monitoring and controlling a complex organism development as claimed in claim 2, characterized in that the computer modeling software program (10) is organized to synchronize an addition, modification or deletion of an object duplicated in the document of said second representation software program (12) with an addition, modification or deletion respectively of an object duplicated in the document of said first representation software program (11).

4. The tool for monitoring and controlling a complex organism development as claimed in claim 3, characterized in that it comprises at least three representation software programs (11, 12, 13) such that the first representation software program enables a working representation of the model, the second representation software program enables a strategic representation of the model and the third representation software program enables a representation of the management of the development of the model.

5. The tool for monitoring and controlling a complex organism development as claimed in claim 4, characterized in that it comprises in memory an object structure or a mapping table (19) referencing an object duplicated by means of a hierarchical identifier comprising a sequence of integers the rank of which in the sequence is representative of a degree of nesting of a component modeled by said duplicated object in the complex organism.

6. The tool for monitoring and controlling a complex organism development as claimed in one of claims 2 to 5, characterized in that it comprises in memory a software program (8) for communication with said modeling software program (10) which is used to construct directly the pivot objects representing the types of sub-components of the organism from which the development is modeled.

7. The tool for monitoring and controlling a complex organism development as claimed in one of claims 2 to 6, characterized in that it comprises in memory a communication software program to set up on a network, a communication session with another digital processor unit, another operator interface or another similar memory.

8. The tool for monitoring and controlling complex organism development as claimed in one of claims 2 to 7, characterized in that the calculation functionalities of the representation software programs (11, 12, etc) are implemented independently in one or more other software programs (15a) and in that other representation display functionalities are implemented by other software programs.
